(19) United States
(12) Patent Application Publication
(10) Pub. No.: US 2003/0230634 A1
(43) Pub. Date: Dec. 18, 2003

(54) Process and device for cleaning at least one glue nozzle

(75) Inventors: Jirko Heide, Schwarzenbek (DE); Martin Paech, Tespe (DE); Dirk Zeuner, Schwarzenbek (DE); Reinhard Deutsch, Geesthacht (DE)

Correspondence Address: GREENBLUM & BERNSTEIN, P.L.C., 1950 ROLAND CLARKE PLACE, RESTON, VA, 20191, US

(73) Assignee: TOPACK Verpackungstechnik GmbH, Schwarzenbek (DE)

(21) Appl. No.: 10/452,239

(22) Filed: Jun. 3, 2003

(30) Foreign Application Priority Data
Jun. 4, 2002 (DE) 102 24 896.6

(51) Int. Cl. A62C 5/02

(52) U.S. Cl. 239/10

(57) ABSTRACT

Process and apparatus for cleaning at least one glue nozzle. The process includes contacting a cleaning organ to the at least one glue nozzle during normal operation of the machine. The apparatus includes a gluing device having at least one glue nozzle and at least one cleaning organ associated with the at least one glue nozzle. The at least one glue nozzle and the at least one cleaning organ are structured and arranged for movement relative to each other, such that the at least one cleaning organ is arranged to clean the at least one glue nozzle during normal operation of the machine. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 102 24 896.6, filed on Jun. 4, 2002, the disclosure of which is expressly incorporated by reference herein in its entirety.

### BACKGROUND OF THE INVENTION

1. Field of the Invention

The present invention relates to a process for cleaning at least one glue nozzle in a machine of the tobacco processing industry or the packaging industry. A cleaning organ is provided to contact the glue nozzle in order to clean the at least one glue nozzle. The invention further relates to a process for operating a gluing device of a machine of the tobacco processing industry or the packaging industry. Finally, the invention relates to a machine of the tobacco processing industry or the packaging industry, e.g., for the production of cigarette packs, with at least one gluing device, which features at least one glue nozzle, for applying glue to elements to be processed in the machine, in particular blanks of cigarette packs. In this manner, at least one cleaning organ is assigned to the at least one glue nozzle, in which glue nozzle and cleaning organ can be moved relative to one another.

2. Discussion of Background Information

A corresponding process and a corresponding machine are known from European Patent Application No. EP 1 000 863 A1. In the packaging machine described, glue nozzles are positioned on a pivot arm and can be moved from a glue application position, to transfer glue to cigarette packs, into a maintenance position in which the glue nozzle is alternatively located above a collecting container for glue portions or above a water container. A rotatable roller of elastic material, e.g., foam, is assigned to the water container, to assume the function of a cleaning and closure organ for the glue nozzle. A corresponding cleaning of the glue nozzle takes place during stoppages of the packaging machine.

### SUMMARY OF THE INVENTION

The present invention provides a process for cleaning at least one glue nozzle and a corresponding machine of the tobacco processing industry or the packaging industry in such a way that the most effective cleaning of glue nozzles can be achieved.

Accordingly, a process for cleaning at least one glue nozzle is provided in a machine of the tobacco processing industry or the packaging industry. In particular, a cleaning organ is provided to be in contact with the glue nozzle to clean the at least one glue nozzle. Further, the at least one glue nozzle is cleaned in the normal operation of the machine.

By cleaning the glue nozzle in the normal operation of the machine, it is possible to clean the nozzle not only during a stoppage, but also during operation of the machine. In this way, the glue nozzle is kept permanently clean and a very efficient cleaning process and a very efficient operation of the machine are rendered possible. Within the scope of this invention, normal operation refers to an operation of the machine in which the usual processing steps are carried out, e.g., gluing of elements to be glued. A particularly simple cleaning process is given if the cleaning organ, which is, in particular, elastic, moves to clean the at least one glue nozzle. Through this measure it is possible that the cleaning organ brushes along the at least one glue nozzle or rubs it so that even glue residue that is stuck tightly can be removed. To this end, the cleaning organ preferably moves during the cleaning of the at least one glue nozzle. Alternatively, or additionally, the glue nozzle can move during cleaning.

The movement is preferably in one direction. However, in another embodiment of the invention, the movement is rocking.

If the cleaning organ is cleaned by a cleaning device, in particular permanently, an efficient cleaning of the at least one glue nozzle is possible. The cleaning of the at least one glue nozzle preferably takes place outside a position of the at least one glue nozzle in which the glue nozzle normally dispenses glue for gluing elements to be processed in the machine. In this connection, the glue nozzle can be arranged, e.g., on a carriage moving in a linear manner and can be moved from a first position, in which the glue is applied to corresponding elements, to a second position in which the at least one glue nozzle is cleaned.

In a particularly preferred embodiment of the invention, the cleaning takes place in a position of the at least one glue nozzle in which the glue nozzle normally dispenses glue for gluing elements to be processed in the machine. In this preferred embodiment of the invention, elements to be glued consecutively and a cleaning organ are brought into the effective range of the at least one glue nozzle.

The process for operating a gluing device of a machine of the tobacco processing industry or the packaging industry provides that, in a first position, glue is applied to elements to be glued, and, in a second position. at least one glue nozzle of the gluing device is cleaned. In this way, the cleaning of the at least one glue nozzle takes place during the normal operation of the machine.

Through the process according to the invention, an efficient and very fast cleaning of the glue nozzles is possible without the normal operation of the machine being interrupted. Through the various possibilities for moving the glue nozzle and the cleaning organ also mentioned above, an efficient utilization of the entire cleaning surface is achieved so that the wear of the cleaning organ is slight and thus the service life of the cleaning organ is great.

If a relative movement of an at least partially elastic cleaning organ to the at least one glue nozzle occurs in the second position, in which the cleaning organ comes into contact with the at least one glue nozzle, a particularly efficient cleaning is given. Furthermore, if the cleaning organ is cleaned, a particularly efficient cleaning of the at least one glue nozzle is given.

Preferably the first position essentially corresponds to the second position.

If during a stoppage of the machine the at least one glue nozzle is sealed to another elastic element, a cleaning of the at least one glue nozzle is possible at larger intervals. To this end, the at least one glue nozzle is moved, e.g., every 5 to 10 minutes from the position to the other elastic element and transferred to a cleaning position.

If, to resume operation of the machine, glue is emitted from the at least one glue nozzle in a third position, in which the glue is preferably collected in a collecting container, the at least one glue nozzle can be made ready for operation again very quickly.

The present invention is directed to the use of a belt that is at least partially elastic and/or liquid-absorbing to clean at least one glue nozzle of a machine of the tobacco processing industry or the packaging industry. By using a belt, a much larger surface is available as a cleaning organ than in the prior art, so that the service life is noticeably increased and the wear is noticeably reduced. The cleaning preferably occurs in the normal operation of the machine.

The invention is also directed to a machine of the tobacco processing industry or the packaging industry, in particular for the production of cigarette packs, in which at least one gluing device featuring at least one glue nozzle is provided to apply glue to elements to be processed in the machine, in particular blanks of cigarette packs. Further, at least one cleaning organ is assigned to the at least one glue nozzle, and the glue nozzle and cleaning organ can be moved relative to one another. Cleaning the at least one glue nozzle can be carried out during normal operation of the machine.

An efficient cleaning of the at least one glue nozzle is possible through the machine according to the invention, where the normal operation of the machine is not disturbed.

The at least one cleaning organ preferably includes at least partially an elastic and/or liquid-absorbing material. This material is particularly well suited to cleaning the at least one glue nozzle, such that the material comes into contact with the glue nozzle and a mechanical friction is produced by corresponding movements on one another. If at least one cleaning organ is at least one section of an endless element or is arranged on at least one section of an endless element, a particularly space-saving construction is possible. In this connection, a first cleaning organ is provided on an outer section of a drum for conveying and gluing packaging parts of a cigarette pack. Within the scope of the invention, the term “drum” also covers the term “roll.”

Tax stamps are also in particular contemplated as packaging parts, so that the preferred embodiment of the invention is provided for applying tax stamps to a cigarette pack and for cleaning the at least one glue nozzle with which glue is applied to the corresponding tax stamps. The section is preferably arranged between two segments for conveying the packaging parts, so that the at least one glue nozzle does not have to be removed from the position provided for applying glue in order for it to be cleaned.

If a first cleaning organ includes a belt that comprises at least partially an elastic and/or liquid-absorbing material, a particularly wear-resistant cleaning organ or a cleaning organ with a long service life is given. The belt can preferably be completely covered by this material on one side or only in parts. In this manner, the sections not provided with this material can also be provided for conveying elements to be glued.

If a second cleaning organ is provided which cleans the first cleaning organ, an efficient cleaning of the at least one glue nozzle is possible.

A squeezing device is possible in particular as a cleaning device for cleaning the material. The squeezing device is preferably correspondingly arranged rollers that are arranged in a liquid bath or a water bath in such a way that the material is compressed, released again and compressed again, in order to thus render possible a rinsing of the material with a cleaning liquid or simply with water. A kind of wringing out of the material preferably takes place. Simpler squeezing devices or squeezing devices comprising still more components can also be provided.

Finally, the invention is attained through a machine of the tobacco processing industry or the packaging industry, in particular for the production of cigarette packs, with at least one gluing device featuring at least one glue nozzle for applying glue to elements to be processed in the machine, in particular blanks of cigarette packs. A cleaning organ is assigned to the at least one glue nozzle, in which the cleaning organ is formed by an endless belt, and in which the belt and the at least one glue nozzle can be brought into contact with one another. Through this machine according to the invention a high service life of the cleaning organ and an efficient way of cleaning the glue nozzle result, in which preferably the normal operation of the machine does not need to be interrupted. The belt preferably comprises at least partially an elastic and/or liquid-absorbing cleaning material. If the cleaning material is a coating on the belt, a high service life of the belt is rendered possible. The remaining part of the belt that is not the cleaning material can essentially withstand great tensional forces without great deflections. With correspondingly high tensional forces, the belt is thus per se not very elastic. It is preferably possible to fix the coating to the belt in a detachable manner, in which in particular a Velcro fastener or an adhesive closure that can be fixed in a detachable manner are conceivable. Within the scope of this invention the term cleaning material also covers the general term material, which has been used in particular above.

The present invention is directed to a process for cleaning at least one glue nozzle. The process includes contacting a cleaning organ to the at least one glue nozzle during normal operation of the machine.

In accordance with a feature of the invention, the at least one glue nozzle can be located within a machine of one of tobacco processing industry or packaging industry.

According to another feature of the instant invention, the process can further include moving the cleaning organ while it is in contact with the at least one glue nozzle. The cleaning organ can include an elastic material. Further, the cleaning organ can be moved in one direction. Moreover, the cleaning organ may be moved in a rocking motion.

The process can also include moving the at least one glue nozzle into contact with the cleaning organ.

Further, the process can include moving the at least one glue nozzle while it is in contact with the cleaning organ.

In accordance with another feature, the process may also include cleaning the cleaning organ in a cleaning device.

Moreover, the contact between the cleaning organ and the at least one glue nozzle can occur at a position outside of a normal operational region of the at least one glue nozzle, in which the at least one glue nozzle emits glue.

Also, the contact between the cleaning organ and the at least one glue nozzle may occur at a position at which the at least one glue nozzle emits glue during normal operation of the machine.

The instant invention is directed to a process for operating a gluing device. The process includes applying glue, at a first position, from at least one glue nozzle onto elements to be glued, and cleaning the at least one nozzle, at a second position, during the normal operation of the machine.

According to a feature of the invention, the gluing device can be located within a machine of one of tobacco processing industry or packaging industry.

In accordance with another feature of the present invention, in the second position, the cleaning can include contacting the at least one glue nozzle to a cleaning organ and, while in contact with each other, moving the at least one glue nozzle relative to the cleaning organ. The process can also include cleaning the cleaning organ.

According to still another feature, the first position and the second position can be essentially a same position.

Moreover, during a stoppage of the machine, the process can further include sealing the at least one glue nozzle to another elastic element. Still further, in resuming operation subsequent to the stoppage of the machine, the process can include emitting glue from the at least one glue nozzle at a third position.

The present invention is directed to a cleaning process in a glue application region of a machine that includes a belt. The process includes cleaning at least one glue nozzle of the machine with the belt.

According to a feature of present invention, the belt at least partially includes an elastic material and the machine is a machine for tobacco processing or for packaging.

Further, the belt can at least partially include a material structured to absorb liquid. The process can occur during normal operation of the machine.

The instant invention is directed to a machine that includes a gluing device having at least one glue nozzle, and at least one cleaning organ associated with the at least one glue nozzle. The at least one glue nozzle and the at least one cleaning organ are structured and arranged for movement relative to each other, and the at least one cleaning organ is arranged to clean the at least one glue nozzle during normal operation of the machine.

In accordance with a feature of the invention, the machine can include one of a tobacco processing industry or a packaging industry machine.

According to another feature of the instant invention, the machine may include a cigarette pack production machine and the at least one glue nozzle can be arranged for applying glue to blanks of cigarette packs.

The at least one cleaning organ can be structured and arranged to contact the at least one glue nozzle.

According to a further feature, the at least one cleaning organ may include at least one of an elastic and water-absorbing material.

The at least one cleaning organ can include at least a section of an endless element or is arranged on at least a section of an endless element. The at least one cleaning organ may be located on an outer section of a drum for conveying and gluing packaging parts of a cigarette pack. The outer section of the drum can be positioned between two segments for conveying packaging parts.

In accordance with a still further feature of the present invention, the at least one cleaning organ can include a first cleaning organ in the form of a belt composed of at least one of an elastic and a liquid-absorbing material. The at least one cleaning organ may further include a second cleaning organ structured and arranged to clean the first cleaning organ. Moreover, a squeezing device can be structured and arranged to clean at least one of the first and second cleaning organ.

According to still another feature of the invention, the at least one cleaning organ can be located in a region of the machine outside of a normal gluing region of the at least one glue nozzle.

The machine can further include a linearly movable carriage, such that the at least one glue nozzle is coupled to the carriage, and the carriage is movable in a glue dispensing region and to a location outside of the glue dispensing region. The at least one organ can be located in the location outside of the glue dispensing region. Further, the carriage can be structured and arranged to move the at least one glue nozzle into contact with the at least one cleaning organ in the location outside of the glue dispensing region. When in contact with the at least one glue nozzle, the at least one cleaning organ can move to remove residue from the at least one glue nozzle. Moreover, the at least one organ can include an endless belt arranged to at least partly circulate in a cleaning fluid to clean the residue removed from the at least one glue nozzle from the at least one cleaning organ.

The present invention is directed to a machine that includes at least one gluing device having at least one glue nozzle, at least one cleaning organ associated with the at least one glue nozzle, in which the at least one cleaning organ includes an endless belt, and the at least one glue nozzle and the endless belt are structured and arranged to brought into contact with each other.

In accordance with the invention, the machine can be one of a tobacco processing industry or a packaging industry machine.

Further, the machine can be a cigarette pack production machine and the at least one glue nozzle can be arranged for applying glue to blanks of cigarette packs.

In accordance with still yet another feature of the present invention, the endless belt can include at least one of an elastic and a liquid-absorbing cleaning material. The cleaning material may be a coating on the endless belt. Further, the coating can be detachably fixed on the endless belt.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates a cross-sectional representation of a part of the machine according to the invention;

FIG. 2 diagrammatically illustrates a cross-sectional representation of another exemplary embodiment of a part of a machine according to the invention;

FIG. 3 diagrammatically illustrates a three-dimensional representation of another exemplary embodiment of a part of a machine according to the invention;

FIG. 4 diagrammatically illustrates a more detailed view of the part of the machine depicted in FIG. 3, albeit in another position;

FIG. 5 illustrates a three-dimensional representation of the part depicted in FIGS. 3 and 4;

FIG. 6 illustrates a plan view of the part of the machine depicted in FIGS. 3 and 4; and

FIG. 7 illustrates a sectional view along line VII-VII depicted in FIG. 6.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

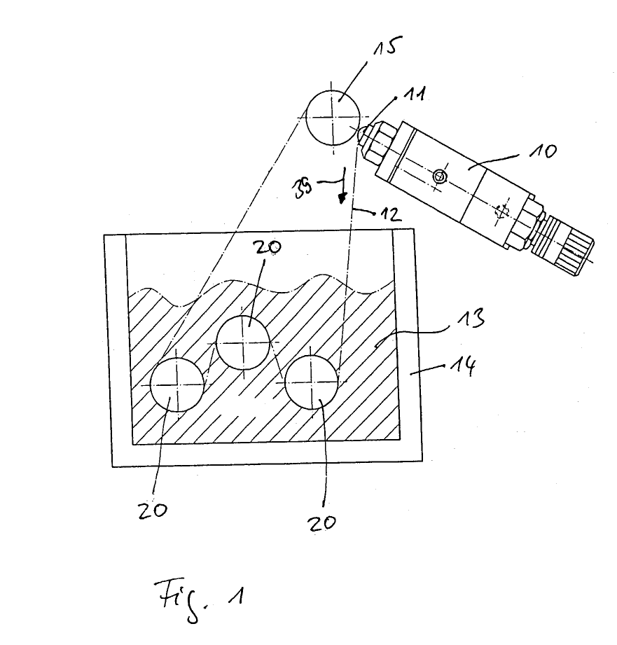

FIG. 1 shows a diagrammatic representation of a part of the machine according to the invention. A gluing device 10 with a glue nozzle 11 presses against a cleaning belt 12, so that by moving cleaning belt 12 in movement direction 39 or by moving glue nozzle 11, preferably crosswise to movement direction 39, a cleaning of glue nozzle 11 occurs. Cleaning belt 12 is guided over rollers 15 and 20 and arrives partially in a liquid 13 in a container 14. Cleaning belt 12 is cleaned in liquid 13, and cleaning belt 12 comprises at least one coating of a flexible and/or liquid-absorbing material or a cleaning material. This material can be, e.g., a sponge. Cleaning belt 12 is squeezed by rollers 20 so that the liquid present in belt 12 is pressed out and clean liquid is allowed in again, so that a kind of rinsing is carried out.

The cleaning operation of glue nozzles 11 can be such that belt 12 runs continuously and the glue valve moves across the width of belt 12 at least in part. Belt 12 can also be further advanced intermittently, where the glue valve moves across the width of belt 12 or a part of it, so that a cleaning takes place through the corresponding contact. Finally, it is possible for belt 12 to move to and fro, and the glue valve stays in one place. A wringing out, e.g., like that of a rag, is reproduced by the squeezing device in the form of rollers 20 located within liquid container 14.

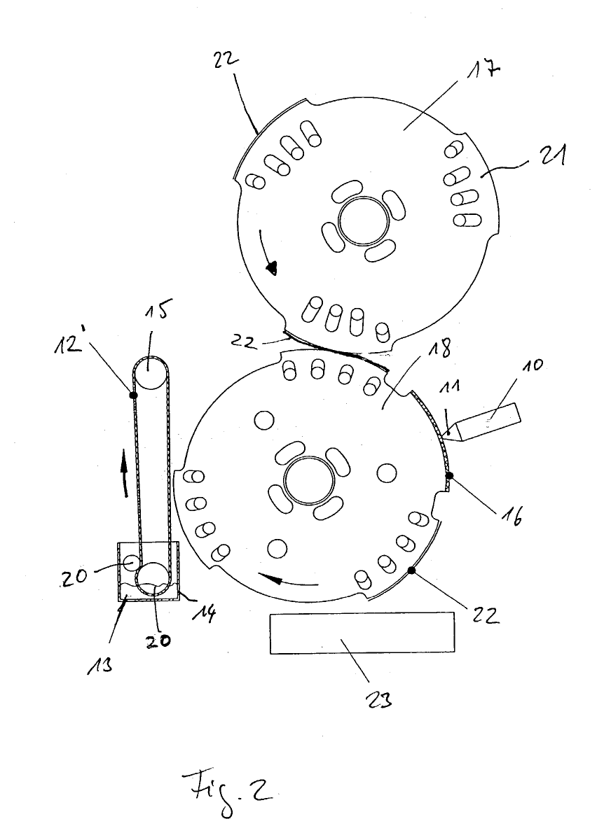

FIG. 2 shows another embodiment of a part of the device according to the invention, where in this exemplary embodiment rolls or drums 17 are provided for gluing tax stamps 22. Corresponding tax stamps 22 are applied to drum 21 and kept there by, e.g., air pressure or suction air. In a transfer position to drum 18, tax stamp 22 is transferred and glued by glue nozzle 11, to then be glued to a cigarette pack 23. In order to clean glue nozzle 11, a cleaning sponge 16 is provided, which is arranged in a section between two segments for holding tax stamps 22. Cleaning sponge 16 comes into contact with glue nozzle 11 at each revolution of drum 18, so that this is effectively cleaned. Cleaning belt 12′, which is located on the other side of drum 18 relative to glue nozzle 11, is deflected around rollers 15 and 20. Cleaning sponge 16 is cleaned by cleaning belt 12′ that is moved against the movement direction of cleaning sponge 16. To this end, glue residue is transferred to cleaning belt 12′ by corresponding friction. Subsequently, in a kind of squeezing device in the form of rollers 20, glue residue on cleaning belt 12′ is squeezed out into liquid 13 in container 14, so that cleaning belt 12′ is clean again after leaving container 14. In this embodiment of the invention, it is not necessary to move the position of glue nozzle 11 for cleaning out of the position in which a gluing of corresponding elements, in particular of tax stamps 22, is provided.

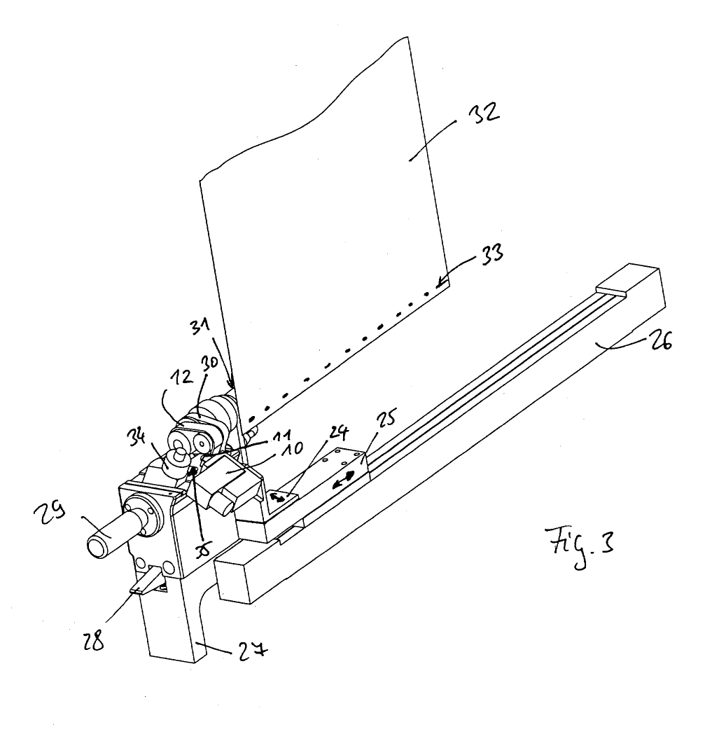

In a further embodiment of the invention, which will be represented below with respect to FIGS. 3 through 7, a different cleaning position compared to the gluing position is provided. A carriage 25 is arranged on a linear unit 26, which carriage can be moved in the direction of the arrow. A holder 24 is provided on carriage 25, which holder can be moved crosswise to the movement direction of carriage 25. By moving carriage 25 on linear unit 26, it is possible by glue nozzle 11 to apply a line of glue 33 on a paper 32 or a paper section 32 within a glue dispensing region of the machine. A line of glue 33 is preferably applied to a paper section 32 on the way to the right in FIG. 3 and on the return a further line of glue 33 on the same paper section 32 or another paper section 32. FIG. 3 shows only the other line of glue 33 that was applied on the return on a paper section 32.

After applying two lines of glue 33, i.e., on either one or two paper sections 32, glue nozzle 11 comes into the effective range of a cleaning device, i.e., outside of the glue dispensing region. The cleaning device includes a cleaning belt 12 and other elements that are not shown in further detail in FIG. 3. Glue nozzle 11 is cleaned in the effective range of glue nozzle 11 with cleaning belt 12, in order subsequently to be moved to the right again, when a further line of glue 33 is applied to a paper section.

In the position of glue nozzle 11 shown in FIG. 3, glue is sprayed into a collecting container 35 after a stoppage so that the glue nozzle is ready for operation again. During the stoppage, the glue nozzle can be placed in a kind of parked position against an elastic closure element 34, so that glue nozzle 11 does not dry out. In order to prevent a drying out in any event, it is provided to bring glue nozzle 11 from closure element 34 into the effective range of cleaning belt 12 every 5 to 10 minutes during the stoppage, so that a cleaning takes place. Subsequently, glue nozzle 11 is again brought into the area of closure element 34 so that a tight seal with closure element 34 is possible. The entire cleaning and closure device can be removed from a frame 27 by a handle 29 and a release 28 in order to replace it quickly and easily or to render possible a simple replacement of the cleaning liquid. Belt 12 is driven by a motor 31 that is attached to a carrier plate 30.

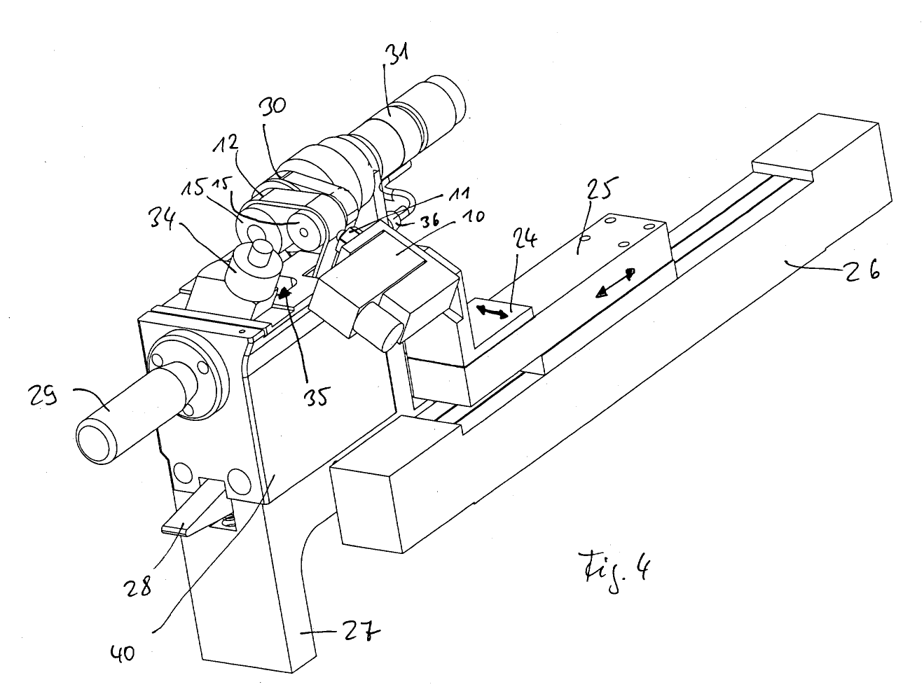

The elements of the part of the machine according to the invention in this embodiment are shown more clearly in FIG. 4. Rollers 15 are also shown around which cleaning belt 12 is deflected. The position of glue nozzle 11 with respect to roller 15, which is opposite glue nozzle 11, can be such that the vertical distance to roller 15 is greater than shown. To this end, cleaning belt 12 with rollers 15 can be arranged higher up or glue nozzle 11 can be arranged lower down. Further, in FIG. 4, a sensor 36 is provided in order to determine whether the cleaning and closure device 40 is present.

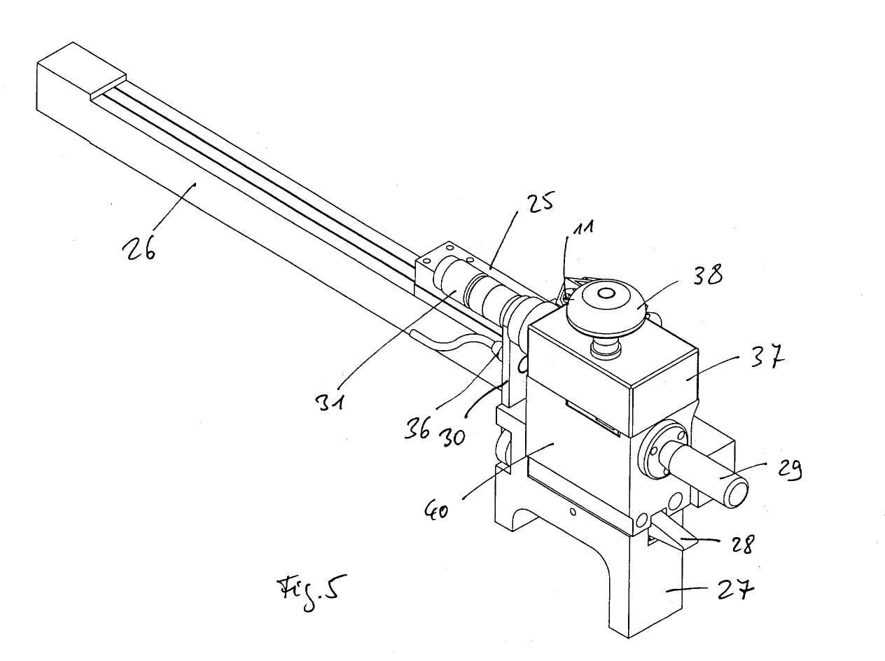

FIG. 5 shows the embodiment of FIG. 4 in a diagrammatic three-dimensional representation from behind, i.e., in which a cover 37 with a handle 38 is additionally shown. Handle 38 is preferably rotatable and is used to connect cover 37 to the lower part. A corresponding cover is preferably used in order to distribute little liquid or glue in the surroundings of cleaning and closure device 40. Handle 29 and release 28 are also preferably provided to remove the liquid container for cleaning purposes. In FIG. 4, glue nozzle 11 is shown in a position in which this is cleaned.

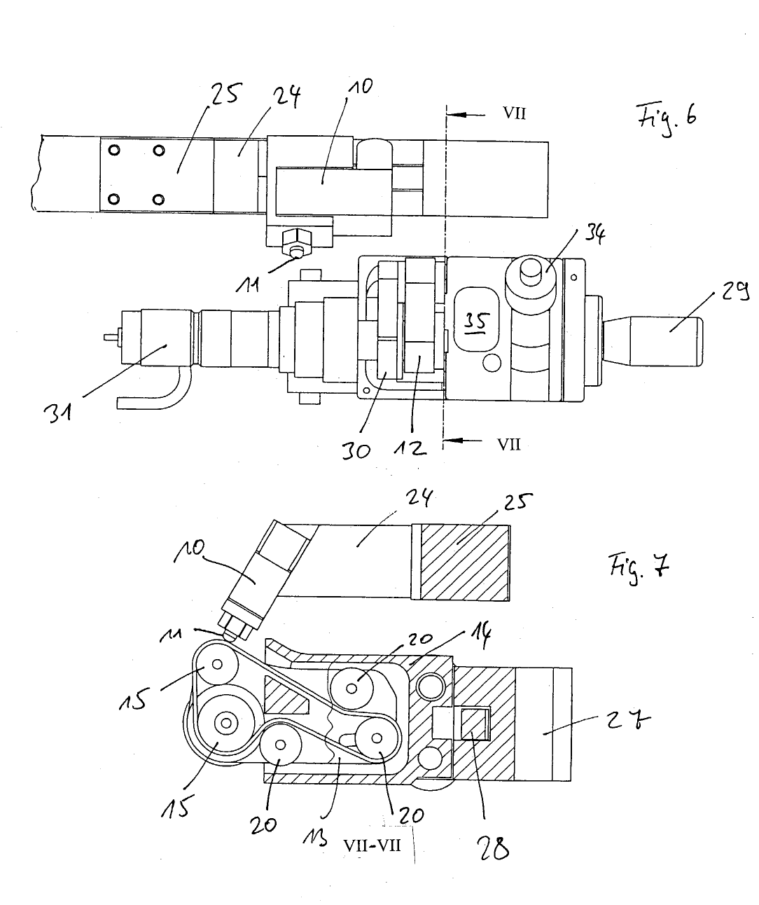

FIG. 6 shows a plan view of the exemplary embodiment from FIGS. 3 and 4, in which, with respect to FIG. 5, cover 37 and handle 38 have been omitted for better illustration. Collection container 35 for glue is shown particularly well.

FIG. 7 shows a cross-sectional representation along the line VII-VII from FIG. 6. It can be seen very well in this exemplary embodiment how cleaning belt 12 itself is cleaned in a liquid. To this end, corresponding rollers 20 are provided, by which a kind of squeezing can be carried out. It should be noted that FIG. 7 is rotated by 90°, i.e., container 14 should naturally be upright, so that liquid 13 remains in this container due to gravity.

According to the invention, glue valve 10 is attached to a carriage 25 of a linear unit 26. At the start of the gluing cycle, carriage 25 stands in an initial position in which there is no gluing. Paper 32 to be glued is advanced, and, as soon as paper 32 comes to a stop, carriage 25, together with glue valve 10 and 11, is moved from the starting point to the end point. Dots of glue are placed in a line of glue 33 at preset points. The end position is arranged laterally next to the paper web and is constructively embodied as a cleaning device. Thus, at every second paper advance and at every second paper gluing, a cleaning of glue valve 10 or glue nozzle 11 takes place. The cleaning preferably occurs on a belt that has an elastic coating on the back. This can also be realized, for example, in a replaceable manner in the form of a Velcro fastener. The cleaning through the use of belts prolongs the service life of the cleaning organ considerably because the surface available for cleaning is very large. The entire surface of the belt can be fully utilized in different ways. To this end, the belt can run continuously and the glue valve can move across the belt width or partially across the belt width. Further, the belt can be advanced intermittently and the glue valve can move across the belt width. Finally, it is possible to provide the belt in a rocking manner so that with a fixed glue valve the belt width can also essentially be fully utilized.

In order to wash the glue out of the belt, the belt is guided in a water container around deflection rollers 20. A kind of squeezing operation, like wringing out a rag, is hereby reproduced. During the stoppages of the machine, the glue must be kept liquid in the discharge channel of glue nozzle 11. To this end, a spray pulse can be provided into collection container 35 every 5 to 10 minutes or, as already shown above, a cleaning can be provided or both can be combined. On starting up the machine after a lengthy stoppage, a spraying into collection container 35 is provided so that glue nozzle 11 functions properly and the functioning of glue nozzle 11 can be checked. During a stoppage of the machine a closure of the glue nozzle takes place behind the cleaning container with an elastic roller, removed from the actual cleaning.

Through the embodiments of the machine according to the invention a cleaning is possible that is available during the normal operation or the proper operation of the machine.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

List of Reference Numbers

10 Gluing device

11 Glue nozzle

12 Cleaning belt

12′ Cleaning belt

13 Liquid

14 Container

15 Roller

16 Cleaning sponge

17 Drum

18 Drum

20 Roller

21 Segment

22 Tax stamp

23 Cigarette pack

24 Holder

25 Carriage

26 Linear unit

27 Frame

28 Release

29 Handle

30 Carrier plate

31 Motor

32 Paper

33 Line of glue

34 Closure element

35 Collecting container

36 Sensor

37 Cover

38 Handle

39 Movement direction

40 Cleaning and closure device

What is claimed:

1. A process for cleaning at least one glue nozzle, comprising:
contacting a cleaning organ to the at least one glue nozzle during normal operation of the machine.

2. The process in accordance with claim 1, wherein the at least one glue nozzle is located within a machine of one of tobacco processing industry or packaging industry.

3. The process in accordance with claim 1, further comprising moving the cleaning organ while it is in contact with the at least one glue nozzle.

4. The process in accordance with claim 3, wherein the cleaning organ comprises an elastic material.

5. The process in accordance with claim 3, wherein the cleaning organ is moved in one direction.

6. The process in accordance with claim 3, wherein the cleaning organ is moved in a rocking motion.

7. The process in accordance with claim 1, further comprising moving the at least one glue nozzle into contact with the cleaning organ.

8. The process in accordance with claim 1, further comprising moving the at least one glue nozzle while it is in contact with the cleaning organ.

9. The process in accordance with claim 1, further comprising cleaning the cleaning organ in a cleaning device.

10. The process in accordance with claim 1, wherein the contact between the cleaning organ and the at least one glue nozzle occurs at a position outside of a normal operational region of the at least one glue nozzle, in which the at least one glue nozzle emits glue.

11. The process in accordance with claim 1, wherein the contact between the cleaning organ and the at least one glue nozzle occurs at a position at which the at least one glue nozzle emits glue during normal operation of the machine.

12. A process for operating a gluing device, comprising:
applying glue, at a first position, from at least one glue nozzle onto elements to be glued; and
cleaning the at least one nozzle, at a second position, during the normal operation of the machine.

13. The process in accordance with claim 12, wherein the gluing device is located within a machine of one of tobacco processing industry or packaging industry.

14. The process in accordance with claim 12, wherein, in the second position, the cleaning comprises contacting the at least one glue nozzle to a cleaning organ and, while in contact with each other, moving the at least one glue nozzle relative to the cleaning organ.

15. The process in accordance with claim 14, further comprising cleaning the cleaning organ.

16. The process in accordance with claim 12, wherein the first position and the second position are essentially a same position.

17. The process in accordance with claim 12, wherein, during a stoppage of the machine, the process further comprises sealing the at least one glue nozzle to another elastic element.

18. The process in accordance with claim 17, wherein, in resuming operation subsequent to the stoppage of the machine, the process further comprises emitting glue from the at least one glue nozzle at a third position.

19. A cleaning process in a glue application region of a machine that includes a belt, the process comprising:
cleaning at least one glue nozzle of the machine with the belt.

20. The cleaning process in accordance with claim 19, wherein the belt at least partially comprises an elastic material and the machine is a machine for tobacco processing or for packaging.

21. The cleaning process in accordance with claim 19, wherein the belt at least partially comprises a material structured to absorb liquid.

22. The cleaning process in accordance with claim 21, wherein the process occurs during normal operation of the machine.

23. A machine comprising:
a gluing device having at least one glue nozzle;
at least one cleaning organ associated with said at least one glue nozzle;
said at least one glue nozzle and said at least one cleaning organ being structured and arranged for movement relative to each other,
wherein said at least one cleaning organ is arranged to clean said at least one glue nozzle during normal operation of said machine.

24. The machine in accordance with claim 23, wherein the machine comprises one of a tobacco processing industry or a packaging industry machine.

25. The machine in accordance with claim 23, wherein said machine comprises a cigarette pack production machine and said at least one glue nozzle is arranged for applying glue to blanks of cigarette packs.

26. The machine in accordance with claim 23, wherein said at least one cleaning organ is structured and arranged to contact said at least one glue nozzle.

27. The machine in accordance with claim 23, wherein said at least one cleaning organ comprises at least one of an elastic and water-absorbing material.

28. The machine in accordance with claim 23, wherein said at least one cleaning organ comprises at least a section of an endless element or is arranged on at least a section of an endless element.

29. The machine in accordance with claim 28, wherein said at least one cleaning organ is located on an outer section of a drum for conveying and gluing packaging parts of a cigarette pack.

30. The machine in accordance with claim 29, wherein said outer section of said drum is positioned between two segments for conveying packaging parts.

31. The machine in accordance with claim 23, wherein said at least one cleaning organ comprises a first cleaning organ in the form of a belt composed of at least one of an elastic and a liquid-absorbing material.

32. The machine in accordance with claim 31, wherein said at least one cleaning organ further comprises a second cleaning organ structured and arranged to clean said first cleaning organ.

33. The machine in accordance with claim 32, further comprising a squeezing device structured and arranged to clean at least one of said first and second cleaning organ.

34. The machine in accordance with claim 23, wherein said at least one cleaning organ is located in a region of the machine outside of a normal gluing region of said at least one glue nozzle.

35. The machine in accordance with claim 23, further comprising a linearly movable carriage, wherein said at least one glue nozzle is coupled to said carriage, and said carriage is movable in a glue dispensing region and to a location outside of said glue dispensing region.

36. The machine in accordance with claim 35, wherein said at least one organ is located in said location outside of said glue dispensing region.

37. The machine in accordance with claim 36, wherein said carriage is structured and arranged to move said at least one glue nozzle into contact with said at least one cleaning organ in said location outside of the glue dispensing region.

38. The machine in accordance with claim 37, wherein, when in contact with said at least one glue nozzle, said at least one cleaning organ moves to remove residue from said at least one glue nozzle.

39. The machine in accordance with claim 38, wherein said at least one organ comprises an endless belt arranged to at least partly circulate in a cleaning fluid to clean the residue removed from said at least one glue nozzle from said at least one cleaning organ.

40. A machine comprising:
at least one gluing device having at least one glue nozzle;
at least one cleaning organ associated with said at least one glue nozzle, said at least one cleaning organ comprising an endless belt; and
said at least one glue nozzle and said endless belt being structured and arranged to bring into contact with each other.

41. The machine in accordance with claim 40, wherein the machine comprises one of a tobacco processing industry or a packaging industry machine.

42. The machine in accordance with claim 40, wherein said machine comprises a cigarette pack production machine and said at least one glue nozzle is arranged for applying glue to blanks of cigarette packs.

43. The machine in accordance with claim 40, wherein said endless belt comprises at least one of an elastic and a liquid-absorbing cleaning material.

44. The machine in accordance with claim 43, wherein said cleaning material is a coating on said endless belt.

45. The machine in accordance with claim 44, wherein said coating is detachably fixed on said endless belt.
